(19) United States
(12) Patent Application Publication
(10) Pub. No.: US 2002/0139400 A1
(43) Pub. Date: Oct. 3, 2002

(54) Vertical process reactor

(75) Inventor: Dana Scranton, Kalispell, MT (US)

Correspondence Address: LYON & LYON LLP, 633 WEST FIFTH STREET, SUITE 4700, LOS ANGELES, CA, 90071, US

(73) Assignee: Semitool, Inc.

(21) Appl. No.: 09/818,042

(22) Filed: Mar. 27, 2001

(51) Int. Cl. B08B 3/12

(52) U.S. Cl. 134/33; 134/902; 134/155; 134/186; 134/105; 134/153; 134/147

(57) ABSTRACT

A processor for processing microelectronic workpieces includes a process vessel adapted to hold one or more microelectronic workpieces vertically within a rotatable fixture. A drive motor is coupled to the rotatable fixture to spin the rotatable fixture during processing. A processing fluid is introduced into the process vessel for processing of the microelectronic workpieces. The rotatable fixture is raised out of the processor for loading/unloading. The processor can be used to clean, plate, etch, strip, rinse, or dry microelectronic workpieces.

### FIELD OF THE INVENTION

The field of the invention is processing of microelectronic workpieces. More specifically, the field of the invention relates to methods and devices that use liquid-phase or gas-phase processes to clean, plate, strip, etch, rinse, dry or otherwise process microelectronic workpieces. A microelectronic workpiece is defined here to include a workpiece formed from a substrate on which microelectronic circuits or components, data storage elements or layers, or micro-mechanical or optical elements are formed.

### BACKGROUND OF THE INVENTION

During the processing of microelectronic workpieces into, for example, electronic devices such as integrated circuits, the surface of the microelectronic workpiece is exposed to a variety of chemicals. The steps used to process a microelectronic workpiece can include, for example, etching, stripping, rinsing, and drying. Stripping process, for example, are often used to clean the surface of the microelectronic workpiece by stripping photoresist or contaminants that remain on the surface of the workpiece. In etching processes, various chemically reactive substances are used to bathe the microelectronic workpieces.

Cleaning processes are intended to remove photoresist, particulate matter, organic species and other contaminants from the surface of the workpiece. Contaminants that are not removed during cleaning tend to reduce the overall yield of the manufacturing process. This reduces the number of usable electronic components, such as integrated circuits, microprocessors, memory devices, and other flat articles or substrates, etc. that can be obtained from a microelectronic workpiece.

In virtually all process steps used to manufacture microelectronic workpieces, it is important to achieve a high level of process uniformity on each microelectronic workpiece. Process uniformity refers to uniform processing across the surface of an individual microelectronic workpiece as well as to uniform processing of separate microelectronic workpieces contained within a given batch. Maintaining a high level of process uniformity across the surface of an individual microelectronic workpiece can present engineering challenges. Even relatively minor variations in processing parameters can severely degrade the processed microelectronic workpiece.

Processing microelectronic workpieces in batches (in contrast to single microelectronic workpiece processing) further complicates achieving a high level of process uniformity. Batch processes have the inherent advantage of faster and more efficient production when conducting the same processing step. Unfortunately, batch processing has the disadvantage that the workpieces are typically held within a process vessel and are closely spaced together and parallel in an array configuration. This configuration limits the access of processing fluids to the surfaces of the workpieces. Likewise, the array configuration poses problems relating to the ability to control boundary layer conditions on the upper and lower surfaces of the microelectronic workpieces.

Thus, there are increased challenges to achieving process uniformity across the front and back surfaces of the workpieces, because the edges of the microelectronic workpieces are more accessible to the processing fluids than the interior areas. Batch processing accordingly tends to work against process uniformity across a single microelectronic workpiece. Moreover, batch processing can also create non-uniform process conditions with respect to separate microelectronic workpieces in a given batch. For example, the processing fluid more easily accesses the microelectronic workpieces nearest to the ends of the parallel processing array since these microelectronic workpieces are not confined within the interior portion of the processing array.

Further complicating the process challenges described above with respect to batch operations is the fact that there is an increasing need to develop processing devices that occupy smaller physical spaces. For example, if the microelectronic workpieces were spaced further apart from one another to increase process uniformity, the overall size of the processing device would increase significantly. However, large-sized processing devices are undesirable given the large cost required to house the equipment needed to process microelectronic workpieces. Related to the overall trend within the industry for smaller processing devices is the need for processing devices that perform multiple processes. Combining processes that were heretofore performed in separate pieces of equipment reduces the overall equipment cost as well as the physical footprint required to implement the overall processes.

Accordingly, there remains a need for improved methods and devices for processing of microelectronic workpieces. The methods and devices preferably provide uniform processing conditions for the batch processing of microelectronic workpieces. In addition, the methods and devices allow for separate processing steps to be combined into a single device.

### SUMMARY OF THE INVENTION

In a first aspect of the invention, a processor for processing microelectronic workpieces includes a process vessel, a rotatable fixture vertically suspended within the process vessel, wherein the fixture is adapted to hold one or more microelectronic workpieces. The processor includes a motor for rotating the rotatable fixture and a processing fluid inlet and outlet for supplying and emptying, respectively, a processing fluid.

In a second aspect of the invention, the processor for processing microelectronic workpieces includes a process vessel and a rotatable fixture vertically mounted on a shaft within the process vessel, the fixture being adapted to hold one ore more microelectronic workpieces. An inlet and outlet for the processing fluid is provided in the processor for supplying and emptying, respectively, a processing fluid. The processor also includes a motor for rotating the shaft and the rotatable fixture, wherein the motor is located in the base of the process vessel. The shaft is extendible in an axial direction between a lowered position and a raised position for the loading and unloading of microelectronic workpieces.

In a third aspect of the invention independent of any apparatus aspects or elements, a method of processing microelectronic workpieces includes the step of rotating vertically-oriented microelectronic workpieces in the presence of a processing fluid.

In a fourth aspect of the invention, in practicing the method of the third aspect above, the microelectronic workpieces are placed into a rotatable fixture held within a process vessel.

It is an object of the invention to provide improved methods and apparatus for the processing of microelectronic workpieces.

The invention resides as well in subcombinations of the features and steps described. The use of a particular processing fluid is not essential to the invention. The invention broadly contemplates the batch processing of vertically-oriented, rotatable microelectronic workpieces within a process vessel.

### BRIEF DESCRIPTION OF THE DRAWINGS

FIG. 1 is a side section view of a processor with the microelectronic workpieces contained within the process vessel.

FIG. 2 illustrates a processor with the rotational fixture in the raised position for unloading/loading of the microelectronic workpieces.

FIG. 3 illustrates a processor according to a second embodiment with the microelectronic workpieces contained within the process vessel.

FIG. 4 illustrates a processor according to the second embodiment with the rotational fixture in the raised position for unloading/loading of the microelectronic workpieces.

### DETAILED DESCRIPTION

In a method for processing microelectronic workpieces, a liquid-phase or gas-phase processing fluid is provided around vertically oriented workpieces, with the workpieces rotating within that environment. No other steps or apparatus are essential. Vibrational energy is preferably, but not necessarily, introduced to the microelectronic workpieces through the processing fluid.

Various apparatus may be used to perform these methods, and the drawings show some preferred examples.

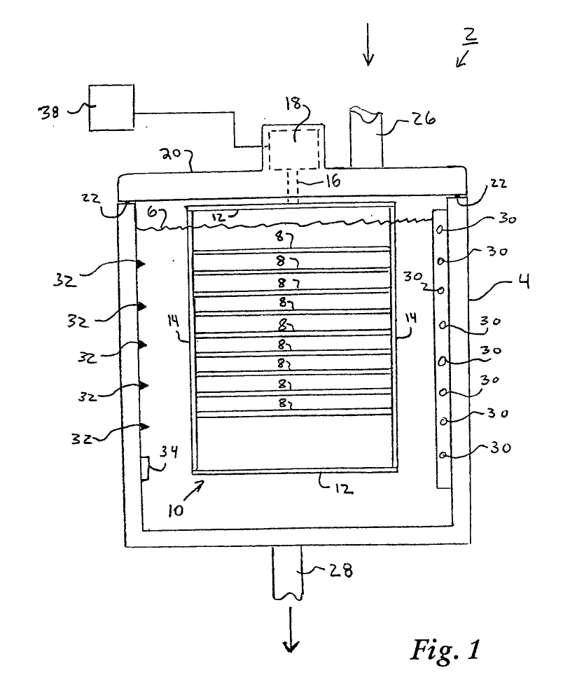

Referring now to FIG. 1, a processor 2 includes a process vessel or tank 4. The term “process vessel” here means walls forming a confined space for at least partially containing a liquid-phase or gas-phase processing fluid 6. A process vessel 4 may have one or more open sides or ends, such as a channel or duct. The processor 2 is used to house microelectronic workpieces 8 during processing. The microelectronic workpieces 8 can include, for example, semiconductor wafers, memory media, optical media, etc. The processor 2 is preferably adapted for use in plating, etching, stripping, cleaning, rinsing, and drying of microelectronic workpieces 8.

A rotatable fixture 10 is supported within the interior of the process vessel 4. The term “rotatable fixture” here means any structure capable of holding microelectronic workpieces 8 during rotation of the microelectronic workpieces 8. The rotatable fixture 10 preferably includes two opposing end plates 12 that are connected by retainers 14. While FIGS. 1-4 show two workpiece retainers 14 that connect the end plates 12 of the rotatable fixture 10, additional workpiece retainers 14 can also be used.

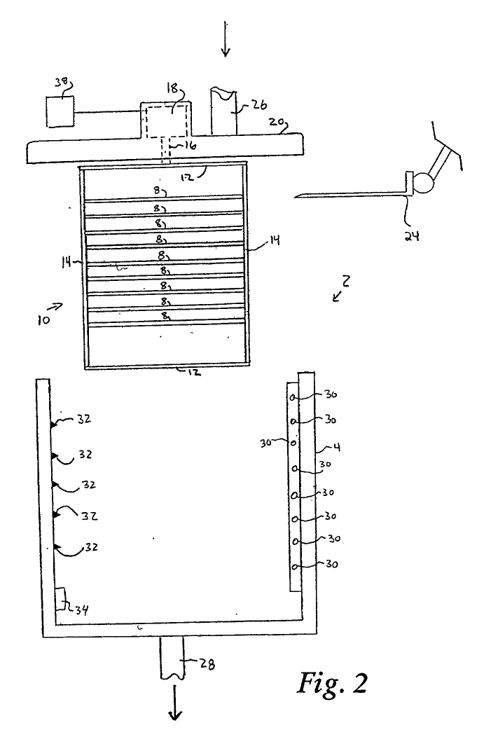

With respect to the embodiments shown in FIGS. 1 and 2, the fixture 10 is rotatably suspended from the top of the process vessel 4. A drive shaft 16 is affixed to one of the end plates 12 of the rotatable fixture 10. The drive shaft 16 is rotatably held by a motor 18 that is preferably external to the interior of the process vessel 4. The spin axis 15 of the drive shaft 16 and the entire fixture 10 is preferably centered within the vessel 4, and perpendicular to the (horizontal) workpieces held in the rotor. The motor 18 is shown in FIGS. 1 and 2 as being held within a lid 20 located atop the process vessel 4. The motor 18, however, may be located elsewhere, or even separate from the processor 2. The lid 20 closes off the top of the process vessel 4 and optionally forms a substantially air-tight seal with the process vessel 4 via seals 22 when the lid 20 is engaged with the process vessel 4. The lid 20 thus reduces or prevents the escape of processing fluid 6 during the processing of microelectronic workpieces 8.

As best seen in FIG. 2, the lid 20 is removable from the process vessel 4 to allow for the loading and unloading of microelectronic workpieces 8. While FIG. 2 illustrates the lid 20 separating completely from the process vessel 4, the lid 20 can also open by other means (e.g., pivoting, sliding, etc.). In these instances, the motor 18 may or may not be secured to the lid 20. For some applications, a lid 20 is not necessary and may be omitted.

FIG. 2 also illustrates a robotic transfer device 24 that is used to load/unload the microelectronic workpieces 8 in the rotatable fixture 10. When the rotatable fixture 10 is in the raised position, (the load/unload position), the robotic transfer device 24 can transfer individual microelectronic workpieces 8 into and out of the rotatable fixture 10.

Referring now to FIGS. 1-3, the process vessel 4 includes at least one inlet port 26 that is used to deliver processing fluid 6 into the process vessel 4. While FIGS. 1-3 show the inlet port 26 located within the lid 20, the inlet port 26 can be located in other locations within the process vessel 4. Similarly, the process vessel 4 includes at least one outlet port 28 that is used to empty processing fluid 6 from the process vessel 4. Preferably, the outlet port 28 is located at the bottom of the process vessel 4, as is shown in FIGS. 1-4.

In a preferred embodiment of the invention, the process vessel 4 includes one or more transducers 30 that are used to deliver vibrational energy to the microelectronic workpieces 8. Preferably, the transducers 30 are situated along the length of the process vessel's 4 inner wall. In another preferred aspect of the invention, spray nozzles 32 are located within the interior of the process vessel 4. The spray nozzles 32 are used to spray processing fluid 6 such as, for example, a rinsing or cleaning agent onto the microelectronic workpieces 8. The process vessel 4 can contain one or more optional heaters 34 that are used to control the temperature of the processing fluid 6 within the process vessel 4.

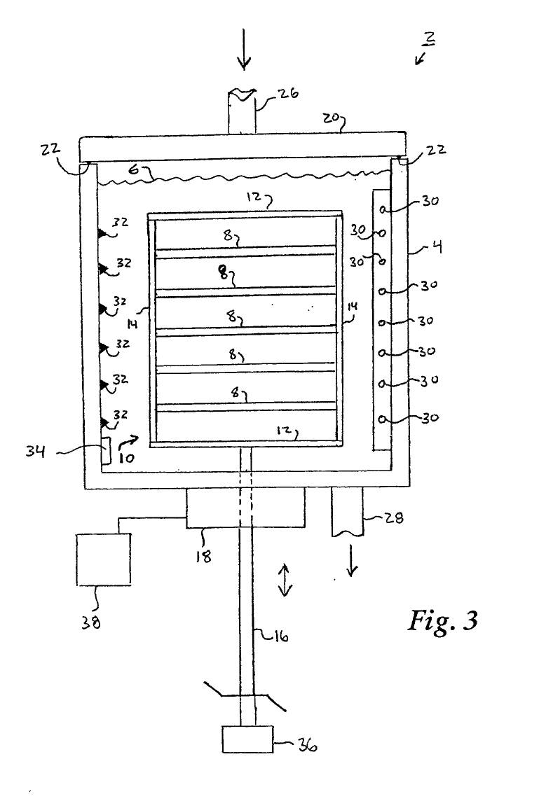

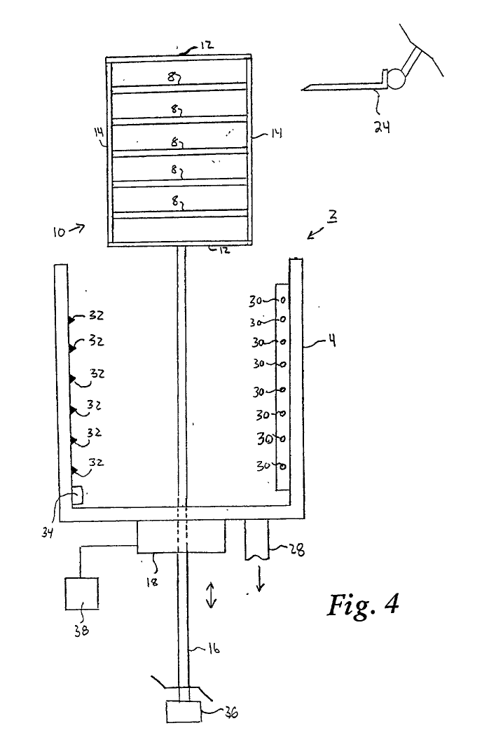

FIGS. 3 and 4 illustrate a separate embodiment of the invention wherein the rotatable fixture 10 is mounted on a drive shaft 16 projecting through the base of the process vessel 4. In this embodiment, the motor 18 that is used to rotate the rotatable fixture 10 is located on the base of the process vessel 4. To load and unload the microelectronic workpieces 8, the rotatable fixture 10 is raised and lowered by the axial movement of the drive shaft 16 relative to the process vessel 4. The motor 18 may optionally provide the driving force through a geared or splined arrangement with the drive shaft 16. Alternatively, axial movement of the drive shaft 16 can be provided by a separate driving system 36. The driving system can operate using gears, hydraulics, pneumatics, or the like.

In the operation of the processor 2, the microelectronic workpieces 8 are loaded into the rotatable fixture 10. The microelectronic workpieces 8 are preferably loaded using a robotic transfer device 24, such as that shown in FIGS. 2 and 4. During the loading/unloading operation, the rotatable fixture 10 is positioned in the raised position in which the rotatable fixture 10 is located above the process vessel 4. The retainers 14 in the rotatable fixture 10 have slots, grooves or combs for receiving and holding the workpieces 8 in a substantially horizontal orientation, i.e., within 5, 10, 15 or 20 degrees of horizontal. The rotatable fixture 10 and microelectronic workpieces 8 are then lowered within the process vessel 4. With the microelectronic workpieces 8 secured in the rotatable fixture 10, the lid 20 is closed (if a lid 20 is used), and optionally sealed on top of the process vessel 4.

Next, processing fluid 6 is introduced into the process vessel 4. The processing fluid 6 can be introduced via the inlet port 26 and/or the optional spray nozzles 32. Depending on the process and the processing fluid 6 that is used, the processing fluid completely immerses the microelectronic workpieces 8 as shown in FIGS. 1 and 3. If the processing fluid 6 is a gas or vapor, the microelectronic workpieces 8 are not immersed per se. Rather, the gas or vapor bathes the microelectronic workpieces 8 within the process vessel 4.

The motor 18 is then turned on to spin the rotatable fixture 10 within the process vessel 4. Preferably, the rotation of the motor 18 is controlled via a controller 38. Depending on the particular process and the processing fluid 6 used, the rotatable fixture 10 is rotated from about 1 to about 3000 rpm, or more preferably, from about 5 to about 600 rpm. The rotation speed depends on the nature of the processing fluid 6, the concentration of the relevant components in the processing fluid 6, the temperature of the processing fluid 6, etc. It should be understood that the invention also contemplates the step of spinning the rotatable fixture 10 prior to the introduction of processing fluid 6.

Optionally, vibrational energy is delivered to the microelectronic workpieces 8 by transducers 30 in the process vessel 4. The vibrational energy of the transducers 30 assists in the treatment of the microelectronic workpieces 8. The transducers 30 are particularly helpful during cleaning processes.

Once the particular processing step is complete, the motor 18 reduces the speed of rotation of the rotatable fixture 10 until the fixture 10 comes to a complete stop. If there are additional processing steps that are required, i.e., rinsing, cleaning, drying, etc., the processing fluid 6 (if any) associated with that step is then administered to the process vessel 4. The motor 18 is again used to spin the rotatable fixture 10. The process is repeated for each step (i.e., rinsing, cleaning, drying, etc.) until the last step is complete and the motor 18 reduces the speed of the rotatable fixture 8 to stop the rotation. The lid 20 (if present) is opened up or removed from the process vessel 4 and the microelectronic workpieces 8 are lifted (as shown in FIG. 2) or pushed (as shown in FIG. 4) outside of the process vessel 4 to a raised position. Preferably, the microelectronic workpieces 8 are removed from the rotatable fixture 10 using the robotic transfer device 24.

The processing fluid 6 used in the processor 2 can be in the liquid phase or gas phase depending on the particular process. The processing fluid 6 can be an etchant, plating solution, stripping agent, cleaning agent, rinsing agent, drying agent, or the like that is commonly used during the processing of microelectronic workpieces 8.

The processor 2 is preferably capable of performing a series of processing steps that are required to produce finished microelectronic workpieces 8. Even more preferably, the processor 2 can completely process the microelectronic workpieces 8, from an initial processing step through final drying. Separate and apart from the processing aspects of the processor 2, the processor 2 can also be used as a buffer-type device to hold microelectronic workpieces 8 in a clean environment. In this aspect, a buffering fluid or the like can be used to maintain the microelectronic workpieces 8 in their existing state until the next processing step.

While embodiments of the present invention have been shown and described, various modifications may be made without departing form the scope of the invention. The invention, therefore, should not be limited, except to the following claims, and their equivalents.

What is claimed:

1. A processor for processing microelectronic workpieces comprising:
a process vessel;
a rotatable fixture within the process vessel, for holding at least one microelectronic workpiece in a substantially horizontal orientation;
a motor for rotating the rotatable fixture; and
a processing fluid inlet and outlet for supplying and emptying, respectively, a processing fluid.

2. The processor according to claim 1, the process vessel further including one or more spray nozzles therein.

3. The processor according to claim 1, the process vessel further including one or more transducers therein.

4. The processor according to claim 1, wherein the rotatable fixture is removable from the process vessel, for loading and unloading workpieces.

5. The processor according to claim 1, the processor further including a removable lid located atop the process vessel.

6. The processor according to claim 1, wherein the removable lid forms a substantially air-tight seal with the process vessel during engagement with the process vessel.

7. The processor according to claim 1, the process vessel further including one or more heaters disposed therein.

8. The processor of claim 1, wherein the motor rotates the rotatable fixture at about 0-3000 rpm.

9. The processor of claim 8, wherein the motor rotates the rotatable fixture at about 5-900 rpm.

10. A processor for processing microelectronic workpieces comprising:
a process vessel;
a fixture within the vessel and rotatable on a shaft about a substantially vertical axis, the fixture having retainers for holding microelectronic workpieces;
a motor for rotating the shaft and the rotatable fixture, the motor being located in the base of the process vessel;
a processing fluid inlet and outlet for supplying and emptying, respectively, a processing fluid; and
wherein the shaft is extendible in an axial direction between a lowered position and a raised position for the loading and unloading of microelectronic workpieces.

11. The processor according to claim 10, the process vessel further including one or more spray nozzles therein.

12. The processor according to claim 10, the process vessel further including one or more transducers therein.

13. The processor according to claim 10, wherein when the shaft is in the raised position, the rotatable fixture is outside the process vessel for loading and unloading of microelectronic workpieces.

14. The processor according to claim 10, the processor further including a removable lid located atop the process vessel.

15. The processor according to claim 10, wherein the removable lid forms a substantially air-tight seal with the process vessel during engagement with the process vessel.

16. The processor according to claim 10, the process vessel further including one or more heaters disposed therein.

17. The processor of claim 10, wherein the motor rotates the rotatable fixture at about 0-3000 rpm.

18. The processor of claim 17, wherein the motor rotates the rotatable fixture at about 5-900 rpm.

19. A method of processing microelectronic workpieces, comprising the steps of:
placing a stacked array of vertically spaced apart microelectronic workpieces into a process vessel;
rotating the microelectronic workpieces within the process vessel about a substantially vertical axis; and
introducing a processing fluid into the process vessel.

20. The method of claim 19 further including the step of loading the workpieces into a rotatable fixture.

21. The method of claim 20, wherein the microelectronic workpieces are loaded into the rotatable fixture while the fixture is outside of the process vessel.

22. The method of claim 19, wherein the rotatable fixture is rotated between about 0-3000 rpm.

23. The method of claim 22, wherein the rotatable fixture is rotated between about 5-900 rpm.
